(19) United States
(12) Patent Application Publication
(10) Pub. No.: US 2019/0091971 A1
(43) Pub. Date: Mar. 28, 2019

(54) METHOD FOR PRODUCING A COMPOSITE PANE HAVING AN INFRARED-REFLECTING COATING ON A CARRIER FILM

(71) Applicant: SAINT-GOBAIN GLASS FRANCE, Courbevoice (FR)

(72) Inventors: Marcel KLEIN, BAESWEILER (DE); Uwe VAN DER MEULEN, NIDEGGEN (DE)

(21) Appl. No.: 15/738,975

(22) PCT Filed: Oct. 20, 2016
(86) PCT No.: PCT/EP2016/075287

§ 371 Date: Mar. 26, 2018

(30) Foreign Application Priority Data
Oct. 23, 2015 (EP) 15191189.8

(51) Int. Cl. B32B 17/10

(52) U.S. Cl. CPC B32B 17/10036; B32B 17/10201; B32B 17/1088; B32B 17/10293; B32B 17/10761; B32B 17/1022

(57) ABSTRACT

A method for producing a composite pane is presented. A first laminating film is placed on an electrically conductive coating of a carrier film, and the carrier film and the first laminating film are then joined to form a bilayer. The bilayer is arranged on an outer pane such that the first laminating film lies areally on the outer pane, and a second laminating film is arranged on the bilayer such that the second laminating film lies areally on the carrier film. An inner pane is placed on the second laminating film, and a composite pane is formed by autoaclaving a layered stack formed by the panes, films and coatings.

The invention relates to a method for producing a composite pane with an infrared-reflecting coating on a carrier film.

Panes in the automotive sector that are equipped with an infrared-reflecting electrically conductive coating are well known to the person skilled in the art. Due to their infrared-reflecting properties, such coatings reduce undesirable heating of the interior by solar radiation. The coatings used have, in general, good electrical conductivity, which enables heating of the coating such that the pane can be kept free of ice and condensation. The coatings include electrically conductive layers, in particular based on silver. The coatings are usually contacted electrically with two busbars, between which a current flows through the heatable coating. This type of heating is, for example, described in WO 03/024155 A2, US 2007/0082219 A1, and US 2007/0020465 A1, which disclose layer systems made of a plurality of silver layers, which further reduce the sheet resistance of the conductive coating. Such coatings are not only electrically heatable, but also have infrared-reflecting properties, by means of which heating of the vehicle interior is reduced even with long standing periods of a vehicle. These layer systems are thus particularly significant not only in terms of safety aspects, such as unrestricted vision, but also from an ecological standpoint, such as reduction of harmful emissions and improvement of vehicle comfort.

Methods such as magnetically enhanced cathodic sputtering for the deposition of such layer systems are well known to the person skilled in the art. The transparent infrared-reflecting electrically conductive coating can be deposited either on one of the inward sides of the outer pane or of the inner pane or on a carrier film that is inserted between the panes. Direct deposition of the coating on one of the pane surfaces is economically advantageous especially with production of large quantities, while the use of a carrier film having an infrared-reflecting coating enables substantially higher flexibility with regard to production.

EP 0 371 949 A1 discloses a composite glass pane with solar protection coating that includes two laminating films and a carrier film positioned therebetween having one metallic and one dielectric layer. The method for producing such a pane includes, in a first step, the production of a trilayer made of laminating films and a coated carrier film, wherein the carrier film is inserted between the laminating films. This has the advantage that the scratch-sensitive surface of the coating is protected by a laminating film.

To guard against corrosion of the infrared-reflecting coating by moisture and environmental influences, the edge region of the coating is electrically insulated or, in the case of a coated carrier film, the carrier film is cut back in the edge region. However, with the use of a trilayer made of laminating films and a carrier film in accordance with EP 0 371 949 A1, a selective cutback of the carrier film is difficult since it is covered on both sides by laminating films. The handling of an individual carrier film having one infrared-reflecting coating is likewise disadvantageous since the coating is sensitive and is easily scratched.

US 2002/0094407 A1 presents a method, wherein a carrier film with a superstructure of one or a plurality of thin layers with thermal properties is inserted between two laminating films inserted and laminated with two panes. Described, among other things, is the production of an intermediate layer consisting of only a carrier film with a superstructure or of a carrier film with a superstructure and a laminating film. In the latter case, the sequence PVB/PET/functional layer(s) is mandatory, with the functional layer(s) being exposed to the external environment. Regardless of the actual sequence, the plies of the intermediate layer are not connected to one another, instead, only the composite made of two panes, two laminating films, and the intermediate layer is interconnected.

The object of the present invention is to provide a method for producing a composite pane having an infrared-reflecting coating on a carrier film, in which damage to the infrared-reflecting coating is prevented and a cutback of the carrier film in the edge region by simple means is possible.

The object of the present invention is accomplished according to the invention by a method for producing a composite glass pane according to claim 1. Preferred embodiments are disclosed in the subclaims.

The invention relates to a method for producing a composite pane comprising the steps
a) Providing a carrier film having an infrared-reflecting coating,
b) Placing a first laminating film on the infrared-reflecting coating of the carrier film,
c) Joining the carrier film and the first laminating film to form a bilayer,
d) Placing the bilayer on an outer pane or inner pane, wherein the first laminating film lies areally on the outer pane or inner pane, and placing a second laminating film on the bilayer, wherein the second laminating film lies areally on the carrier film,
e) Placing an outer pane or inner pane on the second laminating film,
f) Autoclaving the layer stack, comprising in this order
   the outer pane,
   the bilayer made of the first laminating film (with the first laminating film in contact with the outer pane) and the carrier film having an infrared-reflecting coating (having an infrared-reflecting coating in its interior between the carrier film and the first laminating film),
   the second laminating film, and
   the inner pane
      to form a composite pane.

In this method according to the invention, first, in steps b) and c), a bilayer made of the first laminating film and the carrier film is created, wherein the infrared-reflecting coating lies between the carrier film and the first laminating film. Thus, the infrared-reflecting coating is protected against scratches and corrosion and can thus be further processed without corresponding precautions.

Methods known according to the prior art use, in contrast, film configurations in which the infrared-reflecting coating is exposed, in other words, unprotectedly subjected to the external environment. During the production process, either an individual carrier film having an infrared-reflecting coating is processed or a bilayer made of the first laminating film and the carrier film is used, whose coating is not covered by the laminating film. Such an exposed coating must be protected against rough surfaces and moisture. To that end, complex measures must be taken during the production process, such as, the wearing of gloves and a mask by the production workers. Even the moisture brought by a fingerprint or a drop of saliva suffices to produce, under heating in the autoclave process, a corrosion site that is clearly visible in the end product. Such product defects can be completely avoided by means of the method according to the invention.

Preferably, in step c), the bilayer is placed on the outer pane; and in step e), the layer stack is completed by the inner pane. Due to the three-dimensional bending of panes, it is advantageous for the bilayer to be placed on the inner side of the outer pane, which usually has a concave bend, by which means positioning of the layer stack is simplified.

After the treatment of the layer stack in the autoclave according to step f) of the method according to the invention, the outer pane and the inner pane are joined to one another via the intermediate layer made of laminating films and the carrier film, with the infrared-reflecting coating being arranged areally between the outer pane and the inner pane.

The composite pane produced according to the method of the invention comprises an inner pane and an outer pane. The term “inner pane” refers to that pane that is turned, in the installed position, toward the interior of the vehicle. The term “outer pane” refers to that pane that that is turned, in the installed position, toward the external surroundings of the vehicle.

When a first layer is arranged areally “above” a second layer, this means, in the context of the invention, that the the first layer is arranged farther from the nearest substrate than the second layer. When a first layer is arranged “below” a second layer, this means, in the context of the invention, that the second layer is arranged farther from the nearest substrate than the first layer.

A layer, in the context of the invention, can be made of one material. However, a layer can also include two or more individual layers of different materials.

When a first layer is arranged above or below a second layer, this does not necessarily mean, in the context of the invention, that the first and the second layer are situated in direct contact with one another. One or a plurality of other layers can be arranged between the first and the second layer so long as this is not explicitly precluded. If a first and a second layer are immediately adjacent one another, no other layers are situated between the first and the second layer and they are areally in direct contact.

In a preferred embodiment of the method according to the invention, the carrier film and the first laminating film are joined in step c), under pressure at a temperature of 40° C. to 80° C., to form a bilayer. In this temperature range, the films exhibit good adhesion to one another. Thus, the infrared-reflecting coating is well protected between the carrier film and the first laminating film, since no foreign particles can enter the bilayer. With excessively low temperatures, failure of the adhesion between the laminating film and the carrier film can occur during the subsequent further processing of the bilayer. Excessively high temperatures result in the fact that the films can no longer be detached from one another without residue and without damage. It has been demonstrated that a temperature range from 45° C. to 65° C. is particularly well suited to producing a bilayer with sufficient adhesion but not excessive adhesion. In particular, the first laminating film and the carrier film are joined at a temperature of 55° C.

Preferably, the carrier film and the first laminating film are, in each case, rolled from a roll, joined to form a bilayer, and the bilayer is rolled onto a roll. For producing the bilayer, the carrier film and the laminating film present in rolled-up form can be unrolled, heated, for example, by passage through a furnace, and subsequently pressed together by a press or a pair of rollers. In a preferred embodiment, the carrier film and the first laminating film are unrolled in a continuous production process, placed one atop the other, and joined to one another by a heated pair of rollers. The pressure of the rollers and the transfer of heat to the films during passage through the rollers suffice to obtain sufficient adhesion of the films. The bilayer itself can thereafter also be brought back to roll form, simplifying storage and transport of the bilayer.

The method steps combined in step d) (placing the bilayer on a pane and placing a second laminating film on the bilayer) can be done in any order. Thus, the bilayer can first be placed on the outer pane and then covered with a second laminating film; or, alternatively, in a first step, the second laminating film can be placed on the bilayer and then the layer stack placed on the outer pane.

Optionally, in step d) before the placement of the second laminating film, the carrier film having an infrared-reflecting coating is removed at least in an edge region of the composite pane. Here, the edge region is defined as the portion of the carrier film situated within a distance x from the peripheral edge of the panes (outer pane, inner pane). Usually, the distance x has values between 3 mm and 350 mm such that a cutback of the carrier film in the edge region is done by this amount. The value x depends not only on the use and shape of the pane (e.g., side window, rear window, or windshield), but also varies within one composite pane. Particularly, in the case of windshields, there is a comparatively larger cutback on the engine edge of the pane (e.g., x between 200 mm and 350 mm), whereas on the roof edge (e.g., x=20 mm) and on the lateral A-pillars (e.g. x=10 mm), a substantially smaller cutback is made. In this context, the term “engine edge” is the edge of the composite pane turned toward the the engine compartment after installation in a vehicle body, whereas the opposite “roof edge” borders the roof liner of the vehicle. Defined as “A-pillars” are the A-columns of the vehicle body that are situated between the windshield and the side windows. The cutback is even variable within one pane edge. Thus, the value x on the engine edge usually increases starting from the A-pillars in the direction of the center of the engine edge.

A similar course is present on the roof edge depending on the design. The size of the coated carrier film is, accordingly, selected somewhat smaller than the size of the two laminating films. The region without carrier film is to be covered because of its small width by an opaque screenprint, as is customary in the prior art. The transition between the edge strip without the carrier film and the rest of the pane is thus obscured by the screenprint and is not visible as a visually disruptive edge. In the edge region of the composite pane, the two laminating films lie directly on one another. The carrier film having an infrared-reflecting coating is completely surrounded by the laminating films such that corrosion of the infrared-reflecting coating due to environmental influences, such as moisture, is prevented.

Also, in step d) the removal of the carrier film in other regions may be necessary, for example, with the use of sensors behind the composite pane. With the use of sensors that receive or transmit radiation in the infrared range of the spectrum, the infrared-reflecting coating must be removed in the area of operation of the sensor. For this, the carrier film having an infrared-reflecting coating is removed before the placement of the second laminating film in the region of at least one sensor window. Thus, in the region of the sensor window, the two laminating films lie directly on one another after removal of the carrier film. In a possible embodiment, the sensor window borders directly on the peripheral cutback of the carrier film. In this case, the cutback of the carrier film in the region of the sensor window can be done at the same time as this.

The infrared-reflecting coating preferably contains silver and/or an electrically conductive oxide, particularly preferably silver, titanium dioxide, aluminum nitride, and/or zinc oxide, with silver most particularly preferably used.

The infrared-reflecting coating is preferably transparent. In the context of the invention, this means a coating that has light transmittance greater than 70% in the spectral range from 500 nm to 700 nm. This is thus a coating intended and suitable for application on the full area of the pane with through-vision retained. Some of the infrared-reflecting coatings known in the automotive sector have, at the same time, very good electrical conductivity, which enables heating of the pane by application of an electrical voltage to the coating. In a preferred embodiment, the infrared-reflecting coating according to the invention is an electrically conductive coating. The infrared-reflecting electrically conductive coating has at least one electrically conductive layer. The coating can, additionally, have dielectric layers that serve, for example, for regulation of the sheet resistance, for corrosion protection, or for reducing reflection. The conductive layer preferably contains silver or an electrically conductive oxide (transparent conductive oxide, TCO) such as indium tin oxide (ITO). The conductive layer preferably has a thickness of 10 nm to 200 nm. To improve conductivity with, at the same time, higher transparency, the coating can have a plurality of electrically conductive layers that are separated from one another by at least one dielectric layer. The conductive coating can, for example, contain two, three, or four electrically conductive layers. Typical dielectric layers contain oxides or nitrides, for example, silicon nitride, silicon oxide, aluminum nitride, aluminum oxide, zinc oxide, or titanium oxide. Such infrared-reflecting electrically conductive coatings are not restricted to use in heatable embodiments of the composite pane. Even in panes without a heating function, said infrared-reflecting electrically conductive coatings are used, with the coating fulfilling, in this case, only the purpose of solar protection.

In a particularly preferred embodiment, the infrared-reflecting electrically conductive coating has at least one electrically conductive layer, which contains silver, preferably at least 99% silver. The layer thickness of the electrically conductive layer is preferably from 5 nm to 50 nm, particularly preferably from 10 nm to 30 nm. The coating preferably has two or three of these conductive layers, which are separated from one another by at least one dielectric layer. Such coatings are particularly advantageous, for one thing, in terms of the transparency of the pane and, for another, in terms of their conductivity.

The sheet resistance of the infrared-reflecting electrically conductive coating is preferably from 0.5 ohms/square to 7.5 ohms/square. Thus, advantageous heat outputs are obtained with voltages customarily used in the vehicle sector, with low sheet resistances resulting in higher heat outputs with the same applied voltage.

Examples of layer structures that have both high electrical conductivity and an infrared-reflecting effect are known to the person skilled in the art from WO 2013/104439 and WO 2013/104438.

In a possible embodiment of the method according to the invention, between steps c) and d), at least two busbars are inserted into the bilayer such that the busbars electrically conductingly contact the infrared-reflecting coating. In this case, an electrically conductive coating is used as the infrared-reflecting coating. The busbars are provided to be connected to an external voltage source such that a current flows between the busbars through the conductive coating. The coating thus functions as a heating layer and heats the composite pane as a result of its electrical resistance, for example, to deice or defog the pane.

For applying the busbars, the first laminating film is preferably removed in the regions in which the busbars are to be applied. By means of this cutback of the the first laminating film, the infrared-reflecting electrically conductive coating is accessible and can be electrically contacted via a busbar. Since the bilayer is only a loose pre-composite made of the first laminating film and the carrier film with coating, a region B of the laminating film can be separated by a peripheral cut and lifted off the carrier film without causing damage to one of the layers. After applying the busbars, the cut-out region B of the first laminating film is placed at precisely the location where it was removed, and thus covers the busbars. The bilayer with busbars is then laminated to form a composite pane, as already described, in steps d) to f) of the method according to the invention. During the lamination process, in step f), the laminating films melt such that the cut-out region of the first laminating film is no longer identifiable as such.

The applying of the busbars can be done in particular by placement, printing, soldering, or gluing.

In a preferred embodiment, the busbars are implemented as strips of an electrically conductive film. The busbars then contain, for example, at least aluminum, copper, tinned copper, gold, silver, zinc, tungsten, and/or tin or alloys thereof. The strip preferably has a thickness of 10 μm to 500 μm, particularly preferably of 30 μm to 300 μm. Busbars made of electrically conductive films with these thicknesses are technically easy to make and have advantageous current carrying capacity. The strip can be electrically conductingly connected to the electrically conductive coating, for example, via a soldering compound, via an electrically conductive adhesive or electrically conductive adhesive tape or by direct placement. For improving the conducting connection, a silver-containing paste, for example, can be arranged between the conductive coating and the busbar.

Alternatively, the busbars can be implemented as a printed and fired conductive structure. The printed busbars include at least one metal, preferably silver. The electrical conductivity is preferably realized via metal particles contained in the busbar, particularly preferably via silver particles. The metal particles can be situated within an organic and/or inorganic matrix, such as pastes or inks, preferably as a fired screenprinting paste with glass frits. The layer thickness of the printed busbars is preferably from 5 μm to 40 μm, particularly preferably from 8 μm to 20 μm, and most particularly preferably from 10 μm to 15 μm. Printed busbars with these thicknesses are technically easy to make and have advantageous current conducting capacity.

The infrared-reflecting coating is applied on the carrier film before step a) by physical vapor deposition (PVD), particularly preferably magnetically-enhanced cathodic sputtering (magnetron sputtering). Suitable methods are well known to the person skilled in the art.

The production of the composite glass by lamination is done with customary methods known per se to the person skilled in the art, for example, autoclave methods, vacuum bag methods, vacuum ring methods, calender methods, vacuum laminators, or combinations thereof. The bonding of the outer pane and inner pane is customarily done under the action of heat, vacuum, and/or pressure.

The invention further includes a composite pane that is produced according to the method according to the invention. The composite pane comprises, areally arranged one atop another:
an outer pane with an outer side and an inner side,
a first laminating film on the inner side of the outer pane,
a carrier film with an infrared-reflecting coating, wherein the electrically conductive coating lies on the first laminating film,
a second laminating film, and
an inner pane with an inner side and an outer side, whose inner side lies on the second laminating film.

The first laminating film, the infrared-reflecting coating, and the carrier film are present as a pre-composite in the form of a bilayer. The bilayer consists of a first laminating film, an infrared-reflecting coating, and a carrier film in precisely this order. Since the coating is arranged between the first laminating film and the carrier film, it is protected against damage during handling of the pre-bonded bilayer during the subsequent production process of the composite pane. This enables higher product quality. The person skilled in the art can discern by examining the laminated composite pane whether the first laminating film and the carrier film having an infrared-reflecting coating were used as a pre-bonded bilayer. This is possible, for example, by detection of pressure tracks that are created during mechanical compression of the heated films to form a pre-bonded bilayer.

The infrared-reflecting coating contains at least silver and/or an electrically conductive oxide. Exemplary compositions have already been described in the course of the method according to the invention.

The laminating films contain at least one thermoplastic polymer, preferably ethylene vinyl acetate (EVA), polyvinyl butyral (PVB), or polyurethane (PU) or mixtures or copolymers or derivatives thereof, particularly preferably polyvinyl butyral. The thickness of the laminating films is preferably from 0.2 mm to 2 mm, particularly preferably from 0.3 mm to 1 mm, for example, 0.38 mm or 0.76 mm.

The carrier film preferably contains at least polyethylene terephthalate (PET), polyethylene (PE), or mixtures or copolymers or derivatives thereof. This is particularly advantageous for the handling, stability, and optical properties of the carrier film. The carrier film preferably has a thickness of 5 μm to 500 μm, particularly preferably of 10 μm to 200 μm, and most particularly preferably of 12 μm to 75 μm. Carrier layers with these thicknesses can be advantageously provided in the form of flexible and, at the same time, stable films which can be easily handled.

The outer pane and/or the inner pane preferably contains glass, particularly preferably flat glass, float glass, quartz glass, borosilicate glass, soda lime glass, or plastics, preferably rigid plastics, in particular polyethylene, polypropylene, polycarbonate, polymethylmethacrylate, polystyrene, polyamide, polyester, polyvinyl chloride, and/or mixtures or copolymers thereof.

The thickness of the panes can vary widely and thus be ideally adapted to the requirements in the individual case. Preferably, the thicknesses of the outer pane and the inner pane are from 0.5 mm to 10 mm and more preferably from 1 mm to 5 mm, most particularly preferably from 1.4 mm to 3 mm.

The outer pane, the inner pane, or the intermediate layer can be clear and colorless, but also tinted, frosted, or colored. The outer pane and the inner pane can be made of non-prestressed, partially prestressed, or prestressed glass.

The invention further includes the use of a a composite pane produced by the method according to the invention as a vehicle pane, watercraft pane, or aircraft pane, as structural glazing or architectural glazing, preferably as a vehicle window, particularly preferably as a side window, windshield, or rear window.

The invention is described in detail in the following with reference to drawings and exemplary embodiments. The drawings are purely schematic representations and not true to scale. The drawings in no way restrict the invention.

They depict:

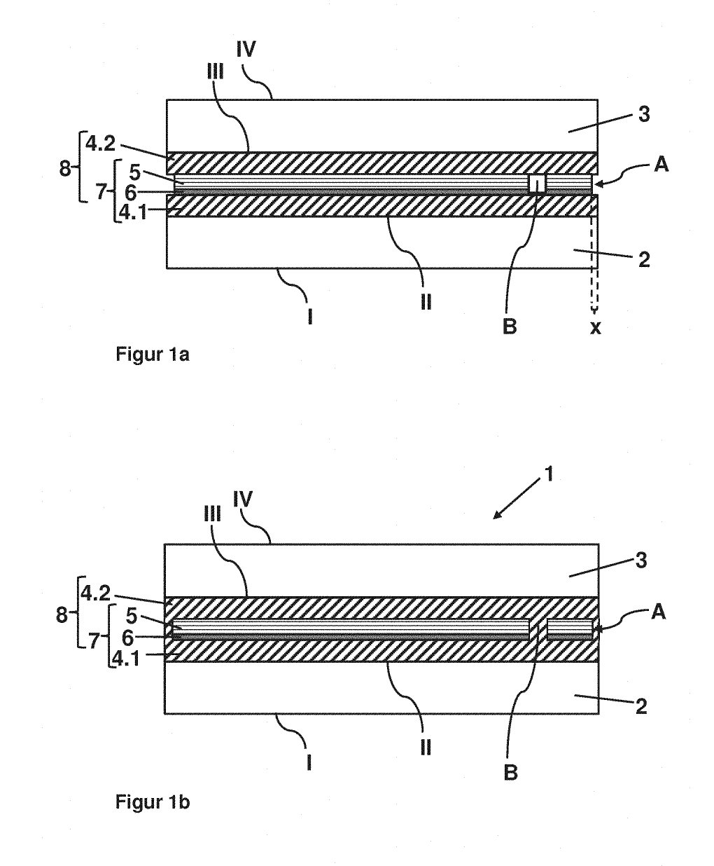

FIG. 1a and 1b a cross-section of a composite pane according to the invention without a heating function,

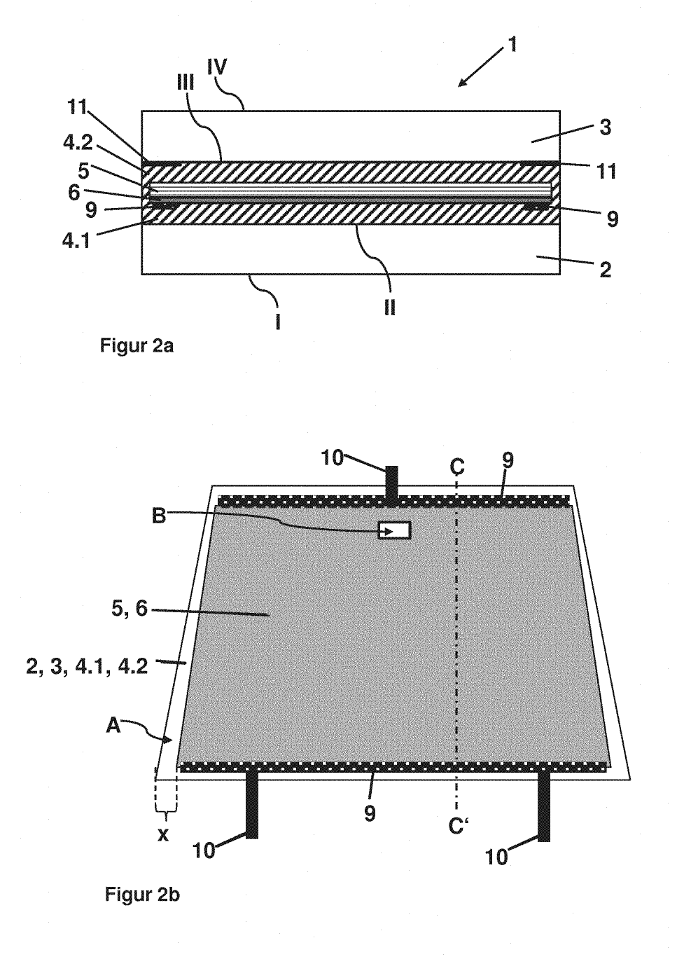

FIG. 2a a cross-section of a composite pane according to the invention with a heating function,

FIG. 2b a plan view of the composite pane according to the invention of FIG. 2a,

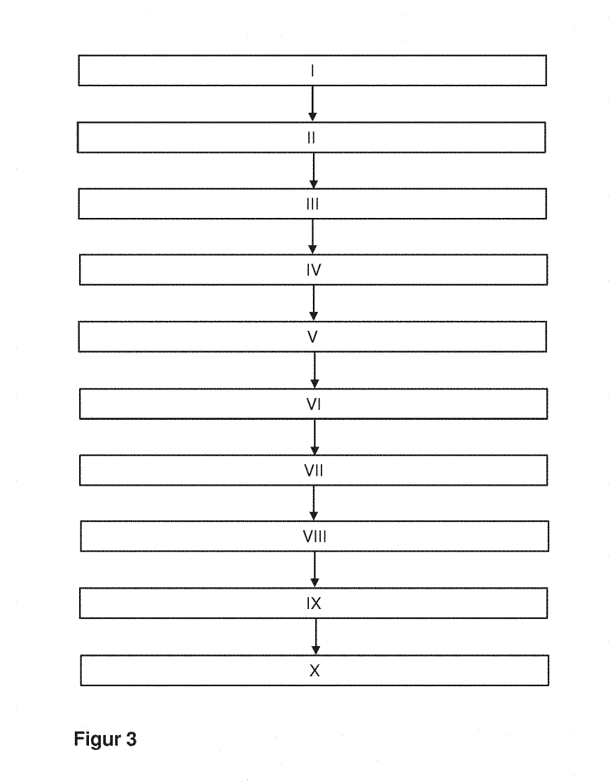

FIG. 3a flowchart of a method according to the invention,

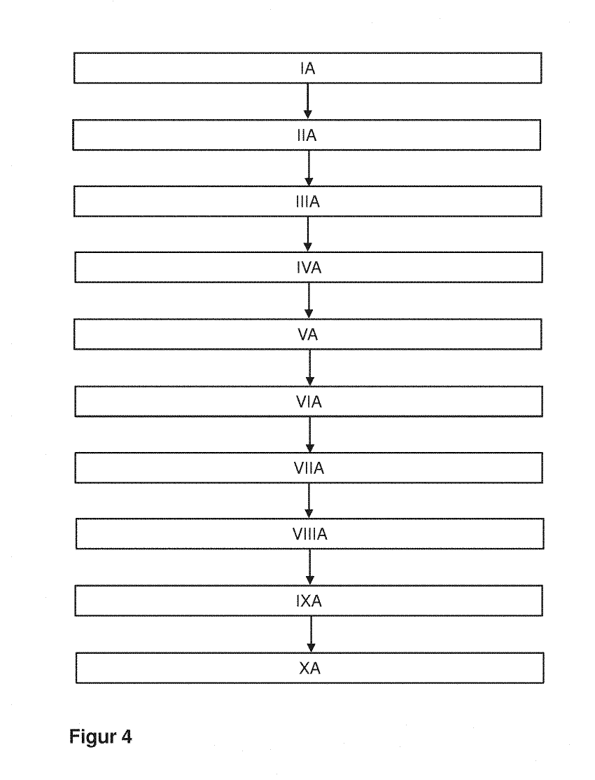

FIG. 4a flowchart of a method not according to the invention as a comparative example

FIG. 1a and 1b depict a cross-section of a composite pane according to the invention 1, here, in an embodiment without a heating function. The composite pane 1 was produced by the method according to the invention described in FIG. 3. The composite pane consists of an outer pane 2 made of soda lime glass with a thickness of 2.1 mm, an intermediate layer 8, and an inner pane 3 made of soda lime glass with a thickness of 1.6 mm. The intermediate layer 8 in turn consists of a bilayer 7 and a second laminating film 4.2. The bilayer 7 is placed on the inner side II of an outer pane 2. The bilayer 7 consists of a first laminating film 4.1 and a carrier film 5 having an infrared-reflecting coating 6, wherein the infrared-reflecting coating 6 lies between the first laminating film 4.1 and the carrier film 5. The bilayer 7 is placed on the outer pane 2 such that the first laminating film 4.1 is areally arranged on the inner side II. The second laminating film 4.2 is areally placed on the carrier film 5 of the bilayer 7. The layer stack ends with an inner pane 3, whose inner side III lies areally on the second laminating film 4.2. After installation of the composite pane 1 in a vehicle, the outer side IV of the inner pane 3 is turned toward the vehicle interior, whereas the outer side I of the outer pane 2 points toward the external environment. The laminating films 4.1, 4.2 are formed, in each case, from a film with a thickness of 0.38 mm. The carrier film 5 is made of a PET film with a thickness of 50 μm, on which a silver-containing coating is applied as an infrared-reflecting coating 6. The infrared-reflecting coating 6 could also be used as a heating layer, since it has adequately high conductivity. However, in this embodiment, it is used only to shield against undesirable thermal radiation. In the edge region A of the composite pane, the carrier film 5 having an infrared-reflecting coating 6 is cut back by an amount x, which defines the distance from the peripheral edge of the composite pane 1, wherein x varies between at least 10 mm at the A-pillars and a maximum of 300 mm at the engine edge. In this edge region A, the carrier film 5 and the infrared-reflecting coating 6 are completely removed. In another region B, the carrier film 5 having an infrared-reflecting coating 6 is removed, since this region is provided for the installation of a sensor behind the composite pane 1 in the interior of the vehicle. In the beam path of the sensor, the infrared-reflecting coating 6 must be removed to ensure unimpeded beam passage and to enable the unrestricted functioning of the sensor. In this region as well, the carrier film 5 is cut out. FIG. 1a depicts the arrangement before lamination, wherein the regions A, B, in which the carrier film 5 is removed, are readily discernible. In these regions A, B, the laminating films 4.1, 4.2 lie directly on one another. FIG. 1b depicts the arrangement of FIG. 1a after lamination of the layer stack to form a composite pane 1. In the edge region A and in the region B of the sensor window, the laminating films 4.1, 4.2 are fused to one another. The laminating films 4.1, 4.2 completely surround the carrier film 5 with coating 6 such that corrosion of the infrared-reflecting coating 6 by environmental influences, such as moisture, can be precluded.

FIG. 2a depicts a cross-section of a composite pane 1 of FIG. 1b, which, in addition to the features described there, has means for heating the composite pane 1. FIG. 2b depicts a plan view of the composite pane 1 of FIG. 2a, wherein the section line C-C′, along which the cross-section of FIG. 2a runs, is indicated. Between the first laminating film 4.1 and the infrared-reflecting coating 6, at two opposite longitudinal edges of the composite panel, busbars 9 in foil form, which electrically conductingly contact the infrared-reflecting coating 6, are inserted into the layer composite. Via connection elements 10, an electric voltage can be applied to the busbars 9, as a result of which a current flows through the infrared-reflecting coating 6 and the composite pane 1 is heated.

FIG. 3 depicts a flowchart of a preferred embodiment of the method according to the invention for producing a composite panel. The composite pane described in FIGS. 1a and 1b was produced using the method of FIG. 3. The method steps depicted in FIG. 3 are as follows:
I Providing a carrier film 5 with an infrared-reflecting coating 6
II Placing a first laminating film 4.1 on the infrared-reflecting coating 6 of the carrier film 5
III Joining the carrier film 5 and the first laminating film 4.1 to form a bilayer 7, wherein the carrier film 5 and the first laminating film 4.1 run through a heated roller pair with a temperature of 55° C. and are pressed together to form a bilayer 7
IV Trimming the bilayer 7 according to the size of the the outer pane 2, wherein the outline of the trimmed bilayer 7 corresponds to the outline of the outer pane 2
V Optional: cutting back the carrier film 5 having an infrared-reflecting coating 6 in the edge region A by an amount x and, to the extent required, in the region B of at least one sensor window
VI Arranging the bilayer 7 on an outer pane 2, wherein the first laminating film 4.1 lies areally in the inner side II of the outer pane 2 and completely covers it
VII Providing a second laminating film 4.2 corresponding to the size of the outer pane 2, wherein the outline of the trimmed second laminating film 4.2 corresponds to the outline of the outer pane 2
VIII Arranging the second laminating film 4.2 on the bilayer 7, wherein the second laminating film 4.2 lies areally on the carrier film 5 and completely covers it
IX Placing an inner pane 3 on the second laminating film 4.2, wherein the inner side III of the inner pane 3 lies areally on the second laminating film 4.2 and completely covers it
X Laminating the layer stack in the autoclave to form a composite pane 1

Using the method according to the invention described in FIG. 3, 70 windshields were produced with the structure described in FIG. 1b. Then, a visual inspection for defects of the infrared-reflecting coating 6 was performed. The number of the panes with defects was 0 (0%). The method according to the invention is thus particularly advantageous in terms of economical and defect-free production with a low rejection rate. Since the infrared-reflecting coating 6 is covered at a very early stage in the production process (already in step II) by the first laminating film 4.1, it is protected in the subsequent production process against damage and environmental influences and defects of the coating can be avoided.

FIG. 4 depicts a flowchart of a method not according to the invention as a comparative example. The steps of the method not according to the invention of FIG. 4 are:
IA Providing a carrier film 5 with an infrared-reflecting coating 6
IIA Placing a second laminating film 4.2 on the uncoated surface of the carrier film 5, wherein a layer stack consisting of (in this order) the second laminating film 4.2, the carrier film 5, and the infrared-reflecting coating 6 is created
IIIA Joining the carrier film 5 and the second laminating film 4.2 to form a bilayer 7A, wherein the carrier film 5 and the first laminating film 4.1 run through a heated roller pair with a temperature of 55° C. and are pressed together to form a bilayer 7A
IVA Trimming the bilayer 7A corresponding to the size of the the outer pane 2, wherein the outline of the trimmed bilayer 7A corresponds to the outline of the outer pane 2
VA Optional: Cutting back the carrier film 5 having an infrared-reflecting coating 6 in the edge region A by an amount x and, to the extent required, in the region B of at least one sensor window
VIA Providing a first laminating film 4.1 corresponding to the size of the outer pane 2, wherein the outline of the trimmed first laminating film 4.1 corresponds to the outline of the outer pane 2
VIIA Arranging the first laminating film 4.1 on an outer pane 2, wherein the first laminating film 4.1 lies areally on the inner side II of the outer pane 2 and completely covers it
VIIIA Arranging the bilayer 7A on the first laminating film 4.1, wherein the infrared-reflecting coating 6 of the carrier film 5 lies areally on the first laminating film 4.1
IXA Placing an inner pane 3 on the bilayer 7A, wherein the inner side III of the inner pane 3 lies areally in the second laminating film 4.2 and completely covers it
XA Laminating the layer stack in the autoclave to form a composite pane 1

The infrared-reflecting coating 6 thus lies exposed after step IIA of the method and is not covered until in step VIIIA by placement of the first laminating film 4.2 on the infrared-reflecting coating of the carrier film 5. Using the method described in FIG. 4, 70 windshields were produced. The basic structure corresponds to the structure described in FIG. 1b, wherein the configuration of the bilayer differs as described in FIG. 4. Then, a visual inspection for defects of the infrared-reflecting coating 6 was performed. The number of panes with defects was 24 (approx. 34%), with 9 panes (approx. 13%) having such serious defects that they had to be discarded.

### List of Reference Characters:

1 composite pane
2 outer pane
3 inner pane
4 laminating films
4.1 first laminating film
4.2 second laminating film
5 carrier film
6 infrared-reflecting coating
7 bilayer
8 intermediate layer
9 busbar
10 electrical connection element
11 screenprint
A edge region with cutback of the carrier film 5
B region without carrier film 5 for sensor window
x cutback of the carrier film 5 at a distance x from the peripheral edge of the composite pane 1
C-C′ section line
I outer side of the outer pane
II inner side of the outer pane
III inner side of the inner pane
IV outer side of the inner pane

1.-13. (canceled)

14. A method for producing a composite pane, the method comprising the following steps:
a) providing a carrier film having an infrared-reflecting coating;
b) placing a first laminating film on the infrared-reflecting coating of the carrier film;
c) joining the carrier film and the first laminating film to form a bilayer ;
d) arranging the bilayer on one of an outer pane and an inner pane so that the first laminating film lies areally on the one of the outer pane and the inner pane, and arranging a second laminating film on the bilayer so that the second laminating film lies areally on the carrier film;
e) placing the other of the outer pane and the inner pane on the second laminating film;
f) based on the steps a)-e), autoclaving a layered stack to form a composite pane that comprises
i) the outer pane;
ii) the bilayer made of the first laminating film and the carrier film having an infrared-reflecting coating;
iii) the second laminating film; and
iv) the inner pane.

15. The method according to claim 14, wherein the carrier film and the first laminating film are joined in step c) under pressure at a temperature of 40° C. to 80° C. to form bilayer.

16. The method according to claim 14, wherein step c) further comprises:
unrolling the carrier film and the first laminating film from a respective roll;
forming the bilayer; and
rolling the bilayer onto a roll.

17. The method according to cliam 14, wherein step d) further comprises:
before the arranging of the second laminating film, removing, in at least one edge region of the composite pane, the carrier film having the infrared-reflecting coating.

18. The method according to claim 14, wherein step d) further comprises:
before the arranging of the second laminating film, removing, in a region of at least one sensor window of the composite pane, the carrier film having the infrared-reflecting coating.

19. The method according to claim 14, further comprising, between step c) and step d):
inserting at least two busbars into the bilayer so that the at least two busbars electrically conductingly contact the infrared-reflecting coating; and
using an electrically conducting coating as the infrared-reflecting coating.

20. The method according to claim 14, wherein the infrared-reflecting coating is applied on the carrier film before step a) by physical vapor deposition.

21. The method according to claim 14, wherein the infrared-reflecting coating contains at least one of: a) silver and and b) an electrically conductive oxide.

22. The method according to claim 14, wherein the first laminating film and the second laminating film contain at least one of: a) polyvinyl butyral (PVB), b) ethylene vinyl acetate (EVA), c) polyurethane (PU), d) mixtures of one or more of a)-c), e) copolymers of one or more of a)-c), and f) derivatives of one or more of a)-c).

23. The method according to claim 14, wherein the first laminating film and the second laminating film have a respective thickness of 0.2 mm to 2.0 mm, preferably of 0.3 mm to 1.0 mm.

24. The method according to claim 14, wherein the first laminating film and the second laminating film have a respective thickness of 0.3 mm to 1.0 mm.

25. The method according to claim 14, wherein the carrier film contains at least one of: a) polyethylene terephthalate (PET), b) polyethylene (PE), c) mixtures of one or more of a) and b), d) copolymers of one or more of a) and b), and e) derivatives of one or more of a) or b).

26. The method according to claim 14, wherein the carrier film has a thickness of 5 μm to 500 μm, preferably 10 μm to 200 μm.

27. The method according to claim 14, wherein the carrier film has a thickness of 10 μm to 200 μm.

28. A composite pane, comprising:
an outer pane;
a bilayer made of a first laminating film and a carrier film having an infrared reflecting coating;
a second laminating film; and
an inner pane.
